(19) United States
(12) Patent Application Publication
(10) Pub. No.: US 2003/0198497 A1
(43) Pub. Date: Oct. 23, 2003

(54) Keyboard with stand-up support

(76) Inventor: Chung Shen Liu, San Chong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/124,233

(22) Filed: Apr. 18, 2002

(51) Int. Cl. B41J 5/08

(52) U.S. Cl. 400/472

(57) ABSTRACT

A keyboard includes an upper member having a top face on which a number of pushbuttons are movably mounted and a lower member having a bottom face. Two legs are pivoted to the bottom face for being movable between a stowed position where the keyboard is allowed to lie down on for example a desk and an extended position where the keyboard is supported in an inclined manner on the desk. Two support members are pivoted to a lateral edge face of the keyboard that connects the top and bottom faces. The support members are movable between a collapsed position to an erected position where the keyboard is supported by the support members in a standing up manner with the lateral edge face substantially confronting the desk for reducing the amount of surface area of the desk occupied by the keyboard and for display purposes.

### BACKGROUND OF THE INVENTION

1. Field of the Invention

The present invention generally relates to a keyboard, such as a computer keyboard, and in particular to a keyboard having a stand-up support for supporting the keyboard in a standing up manner.

2. The Related Art

Keyboards are one of the most commonly employed computer input devices or man-machine interfaces. The keyboard usually has a fiat configuration for lying down on for example a surface of a desk. The keyboard comprises a number of pushbuttons distributed on a top surface thereof whereby the keyboard occupies a great amount of the desk surface on which the keyboard is placed. This causes certain problems to the users of the computer.

In addition, since the conventional designs of keyboards makes the keyboards lying down on a horizontal surface of a desk. Unless additional devices are incorporated to secure the keyboard, otherwise it is in general very difficult, if not impossible, to place the keyboard in a standing up manner for display purposes.

Thus, it is desired to provide a keyboard having a stand-up support for overcoming the above problems.

### SUMMARY OF THE INVENTION

An object of the present invention is to provide a keyboard having a stand-up support for supporting the keyboard in a standing up manner in order to reduce the surface area of a desk that the keyboard may occupy when it is not in use.

Another object of the present invention is to provide a keyboard having a stand-up support for supporting the keyboard in a standing up manner for display purposes.

To achieve the above objects, in accordance with the present invention, there is provided a keyboard comprising an upper member having a top face on which a number of pushbuttons are movably mounted and a lower member having a bottom face. Two legs are pivoted to the bottom face for being movable between a stowed position where the keyboard is allowed to lie down on for example a desk and an extended position where the keyboard is supported in an inclined manner on the desk. Two support members are pivoted to a lateral edge face of the keyboard that connects the top and bottom faces. The support members are movable between a collapsed position to an erected position where the keyboard is supported by the support members in a standing up manner with the lateral edge face substantially confronting the desk for reducing the amount of surface area of the desk occupied by the keyboard and for display purposes.

### BRIEF DESCRIPTION OF THE DRAWINGS

The present invention will be apparent to those skilled in the art by reading the following description of a preferred embodiment thereof, with reference to the attached drawings, in which:

FIG. 1 is an end side elevational view of a keyboard constructed in accordance with the present invention comprising a stand-up support in a collapsed condition;

FIG. 2 is an end side elevational view of the keyboard in a standing up condition;

FIG. 3 is a perspective view of the keyboard of the present invention with the stand-up support in an erected condition; and

FIG. 4 is a perspective view of the keyboard of the present invention in the standing up condition.

### DETAILED DESCRIPTION OF THE PREFERRED EMBODIMENT

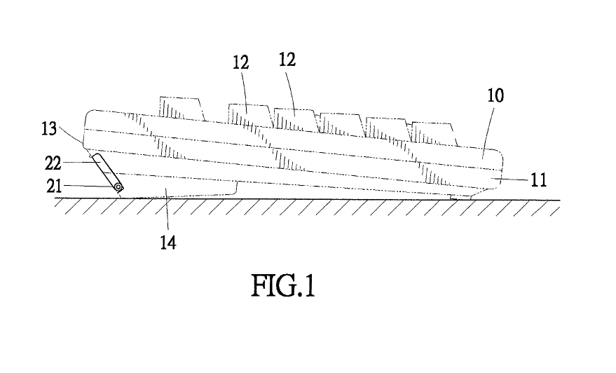

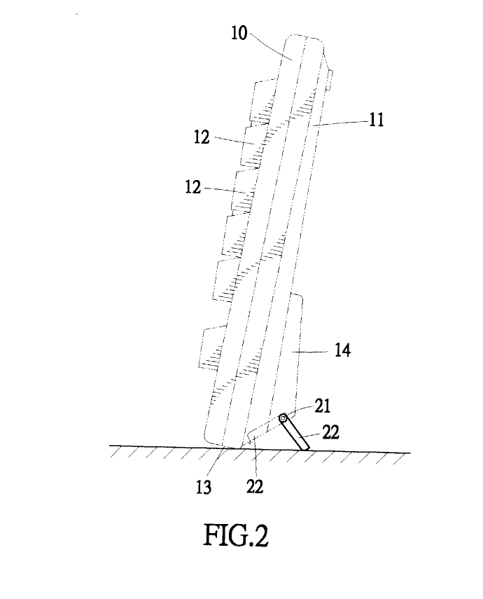

With reference to the drawings and in particular to FIGS. 1 and 2, a keyboard constructed in accordance with the present invention generally comprises a flat body (not labeled) comprising a cover or upper member 10 mounted to a base or lower member 11. The upper member 10 has a top face (not labeled) on which a number of movable pushbuttons 12 are mounted. The lower member 11 of the keyboard has a bottom face (not labeled) substantially opposite to the top face of the upper member 10. Primary support means is formed on the bottom face, comprising a pair of primary legs 14 that are movable between a stowed position where the keyboard is allowed to lie down on for example a desk surface and an extended position where the keyboard is made inclined for conveniently showing the pushbuttons 12 to a user. In the embodiment illustrated, the primary legs 14 are pivoted to the bottom face of the keyboard and rotatable with respect to the keyboard from the stowed position to the extended position for making the top face and thus the pushbutton 12 inclined with respect to the surface on which the keyboard is placed thereby clearly showing the pushbuttons 12 to a user. This is known and thus no further details are needed herein.

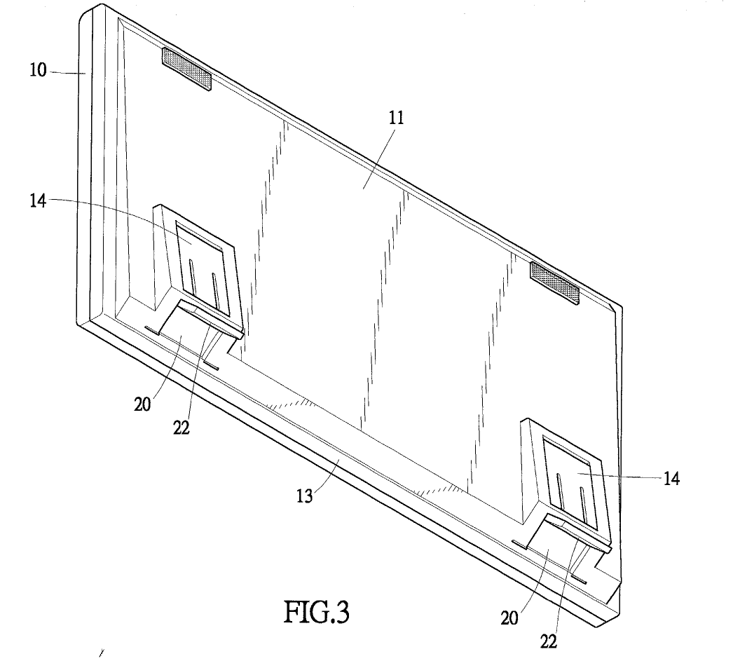

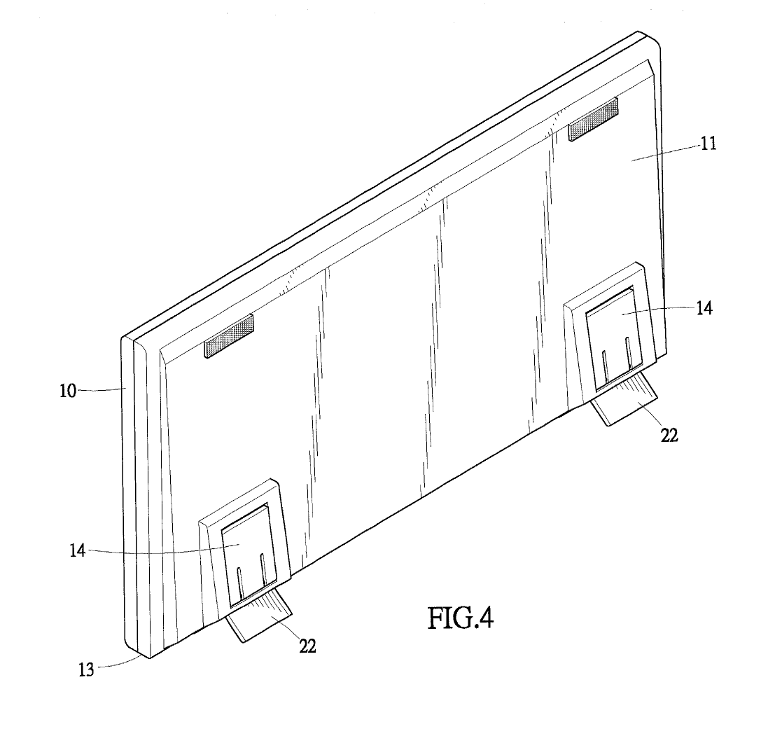

Also referring to FIGS. 3 and 4, the keyboard has a lateral edge face 13 connecting the top and bottom faces. A plurality of recesses 20 is defined in, and preferably spaced along, the lateral edge face 13 for each accommodating a secondary leg or a support member 22. Each support member 22 has a pivot 21 rotatably attaching the support member 22 to the recess 20 of the keyboard whereby the support member 22 is movable between a collapsed position where the support member 22 is received in the recess 20 and an erected position where the support member 22 extends away from the lateral edge face 13 for supporting the keyboard on the desk surface in a standing up manner as shown in FIG. 4 with the lateral edge face substantially confronting the desk surface.

Although the support members 22 are shown to be separated from the primary legs 14 in the embodiment illustrated, the primary legs 14 and support members 22 may be combined together as a single one that is allowed to move (rotate) with respect to the keyboard among a number of different positions where the keyboard may be selectively placed in a lying down manner on the desk surface or standing up on the desk surface.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A keyboard comprising a flat body having first and second opposite major faces and at least one lateral edge face connecting the first and second major faces, at least one support member movably mounted to the body to be movable between a collapsed position and an erected position where the support member extends away from the lateral edge face for supporting the keyboard on an external surface in a standing up manner with the lateral edge face substantially confronting the external surface.

2. The keyboard as claimed in claim 1, wherein the body comprises a plurality of support members spaced from each other along the lateral edge face of the keyboard.

3. The keyboard as claimed in claim 1, wherein the body defines a recess for accommodating the support member in the collapsed position.

4. The keyboard as claimed in claim 1, wherein the support member is pivoted to the body of the keyboard.

5. The keyboard as claimed in claim 1, wherein the body comprises legs movably mounted to the body for moving between a stowed position where the body is allowed to lie down on the external surface with the second major face substantially confronting the external surface and an extended position where the body is supported on the external surface in an inclined manner.
